(19) United States
(12) Patent Application Publication
(10) Pub. No.: US 2014/0304097 A1
(43) Pub. Date: Oct. 9, 2014

(54) Method & System for the automated population of data fields, with personal information, in enrollment/registration forms of service providers

(71) Applicants: ROBERTO MILIAN, Boynton Beach, FL (US); Kim Claassens, Delray Beach, FL (US)

(72) Inventors: ROBERTO MILIAN, Boynton Beach, FL (US); Kim Claassens, Delray Beach, FL (US)

(21) Appl. No.: 13/858,714

(22) Filed: Apr. 8, 2013

(51) Int. Cl. G06Q 30/06; G06F 17/30

(52) U.S. Cl. CPC G06Q 30/0601; G06F 17/30365
USPC 705/26.1

(57) ABSTRACT

A method and system for the electronic enrollment/registration of a consumer for access to the services of a service provider, which requires the selective disclosure of personal consumer information, from a consumer controlled database, to a service provider, as a prerequisite and incidental to the enrollment and/or subscription to a service provider's services. This personal consumer information is resident on a personal database within a mobile consumer communication device (e.g. smart phone) under the control of the consumer. This personal database is only accessible through a communication protocol of the system, which connects the mobile consumer communication device to a consumer controlled gateway resident on a computer server. After select personal information is uploaded to the gateway from the consumer controlled smart phone, the gateway transfers this select data to a service provider for population of its enrollment/registration forms. This method and a system can also be used by the consumer for completion of electronic forms for credit applications, dating sites, magazine subscriptions and the like.

### BACKGROUND OF THE INVENTION

1. Field of the Invention

This invention relates to a system and to a method. More specifically, this invention relates to a novel interactive system for the consumer release of select personal information from a consumer's personal database, via a consumer controlled gateway, to a service provider, for the purpose of enrollment/registration of such consumer as eligible to gain access to such service provider services (e.g. either through the service provider's web site or at its brick and mortar establishment).

2. Description of the Prior Art

The consumer access to various electronically available services, via a web site hosted on the internet, is becoming increasingly common place, and in many instances, has replaced many essential traditional commercial interaction. Typically, the consumer enrolls on the service provider web site, and thereafter can access its services. In many instances, this enrollment, or registration, may require the disclosure of personal information to qualify the consumer for the service provider's services, or to access an existing consumer account, which is electronically accessible through the services provider's corresponding web site on the internet. More specifically, the enrollment or registration of the consumer on the service provider's site can include, as a prerequisite to access to web site access services, the disclosure of personal biographical data and/or personal financial information. In a number of instances, the disclosure of such personal information is used to simply verify the identity of the consumer.

The extent, and type, of information to be provided by the consumer will, thus, vary with the service to be offered on a specific web site, and the extent to which the consumer need to qualify before being eligible to obtain access to the web site services and/or to access/edit his/her own personal account information, for his/her account with the service provider web site.

Accordingly, it goes without saying that web site access, and web site functionality, can require the consumer provide information specific to the individual web site utility and security requirements; and, that for each such web site, the consumer may need to re-enter much of same information (e.g. name, address, social security number, current income, telephone number, email address, etc.), to register and access another site, as he previously provided a web site service provider of an unrelated service. It is also equally apparent that the information necessary for access and/or subscription to each web site, while potentially overlapping, may require information that is unique to the services offered thereon. In a number of instances, consumer personal information also changes with the elapse of time, (e.g. changes in address, phone number, married name and/or age), and thus cannot remain accurate unless it is periodically updated.

A single comprehensive, consumer database, containing detailed personal consumer information relative to financial, medical, demographic and age-specific data, shall necessarily contain, information that, in all likelihood, is neither appropriate nor necessarily responsive, to a forms query from each of the various web sites to which the consumer may desire access. Thus, a consumer is hesitant to provide service provider access to a comprehensive personal database, which contains personal information which may be unnecessary to obtain registration. This reluctance of the consumer to permit unrestricted access to his personal data is of particular consumer concern where personal medical information is included in his/her comprehensive personal database, and access to his/her medical information, is unnecessary for registration, for example, to an on-line banking or shopping service.

The principle web browsers, such as the Microsoft Internet Explorer and Google Chrome, have included, in their respective proprietary browsers, the ability to collect and thereafter recall certain private information, which is unique to individual “visitors” to internet sites through their respective web browsers. These web browsers use this collected personal visitor information to facilitate a repeat visitor's access to mother web site when such access is requested through their respective web browsers. This recall of a repeat visitor's personal information can be as simple as the storing of a screen name or password, or the recall of more detailed visitor information. This storage, recall and use of the visitor's stored information on each of these repeated visits to these web browsers is referred to, (for the purposes of this application), as an “auto fill” feature, or functionality, wherein the stored individual visitor's private information is retrieved from a web browser such as, for example, Microsoft Internet Explorer and Google Chrome.

More specifically, upon a visitor attempted access to a service provider on one these web browsers, the visitor is typically requested to enter an email address, or a screen name, by a web based service provider, upon the visitor seeking to access/register on a web based service provider's page. This screen name or unique electronic signature is then used by the web based service provider to interrogate the personal data files for the visitor, which has been stored within the web browser cache or data module; and, which has been previously used by the visitor to access a web page through its web browser. Where there is personal data for a visitor stored on the web browser, which corresponds to a visitor's screen name or electronic signature which is recognized by the web browser, the personal data is uploaded from the web browser and automatically populates the registration/enrollment form on the service provider's page. Each of Microsoft and Google have obtained patent protection on their Explorer and Chrome web browsers “auto fill” modules for their respective interact web browsers/portals. The following is representative of this “auto fill” patent protection:

U.S. Pat. No. 7,254,569 (to Goodman et al. issued Aug. 7, 2007—assigned to Microsoft Corporation), describes a system and method which can employ certain machine learning techniques to automatically fill one or more fields across a diverse array of web forms. In the Goodman et al. '569 patent, information is collected and maintained in a central repository which is subsequently accessed by the Goodman et al. system. The Goodman et al. system is reportedly capable of learning and adapting the data contained in this repository, to populate (“auto fill”) form data fields from other web sites, Goodman et al. contemplates that its data repository is accessible without prior visitor notice or approval; and, this data repository is inaccessible to the web site visitor to update and/or restrict access to his/her personal data, (e.g. change of address, use of married name of spouse, etc.)

U.S. Pat. No. 7,660,779 (to Goodman et al. issued Feb. 9, 2010—assigned to Microsoft Corporation), is based upon the same patent application as Goodman et al. '569 patent. Goodman et al. '779 patent claims an “auto fill” system, whereas the Goodman et al. '569 patent claims computer executable instructions for performing an “auto fill” method which are stored on a computer readable media.

U.S. Pat. No. 8,335,837 (to Marmaros, issued Dec. 18, 2012—assigned to Google, Inc.) describes a method for transferring web browser data between web browsers, by initially collecting visitor private information who use its browser to access the internet. The collected private information (screen name, password, address, browsing preferences, etc.) is “packaged” into an intermediate format, stored for subsequent import into second web browser. In practice, where the Google Chrome web browser and/or Google search engine is used to browse/search the internet, the user's personal information is collected by Google and stored or packed for subsequent release and transmission to another site (which is accessed through Google) to populate a form on this subsequently accessed site. Obviously, the visitor to the Google web browser or search engine has no control as to either the information which has been collected or its subsequent release and transmission to another web site. It is further apparent that the inaccessibility of the Google data relative to a visitor's private information prevents a visitor from restricting its subsequent release or updating (e.g. change of address, use of married name of spouse, etc.).

Each of the Goodman et al and the Marmaros patents (above discussed) are herein incorporated by reference, in their entirety, to the extent necessary or appropriate to further illustrate and/or supplement the detailed implementation of the embodiments of this system and methods described and claimed hereinafter.

In each of the present “auto fill” environments discussed above, there remains significant privacy issues and, therefore functionality issues/deficiencies because of lack of visitor/consumer access to his/her own personal information to verify its accuracy and/or delete information which he/she desires to maintain confidential/limit dissemination. Notwithstanding, there continues to be a need to facilitate consumer registration and electronic access to diverse service providers sites, and, yet ease the process for registration by means of some automated means specific for each registration process. This need for automation in the registration process, thus, presupposes the existence of a database with relevant personal consumer information, which is accessible and appropriate to populate a service provider's registration forms. The presently available alternatives, as above described), do not, however, provide both effective auto fill alternatives, because of the foregoing privacy concerns, and the need to periodically revise and update such personal information. Thus, there continues to exist the need to alert the consumer of the attempted automated access to his/her personal data, and while allowing him to make a conscious decision as to which service providers are to be given access to his/her personal data, and under what conditions. Also lacking is the ability of the consumer to edit, and to update his/her personal information to reflect changes in his/her residence, phone number, marital status, age, changes in name, and a myriad of other personal data requested as prerequisite to registration.

### OBJECTS OF THE INVENTION

It is the object of this invention to remedy the above as well related deficiencies in the prior art.

More specifically, it is the principle object of this invention to provide an interactive, auto fill data system for electronic enrollment/registration forms requiring consumer release of private information for enrollment to an on-line service provider service.

it is another object of this invention to provide an auto till data system for electronic enrollment/registration having consumer interaction and release of private information for enrollment in an on-line service provider service, wherein said system includes a consumer controlled gateway for restricting/selecting the extent of personal information to be disclosed.

It is yet another object of this invention to provide an auto fill data system for electronic enrollment/registration having consumer interaction and release of private information for enrollment in an on-line service provider service, wherein said system includes a consumer controlled gateway which transmits registration specific private consumer information in response to a service provider in response to a registration forms query.

It is still yet another object of this invention to provide an auto fill data system for electronic enrollment/registration having consumer interaction and release of private information for enrollment in an on-line service provider service, wherein said system includes a consumer controlled gateway, which transmits registration specific private consumer information, in response to a service provider registration forms query for enrollment in one or more web based service providers, while precluding the access to private information which is unnecessary and unresponsive to registration forms queries from one or more web based service providers.

Additional objects of this invention include a method for electronic enrollment/registration of a consumer for access to the services of a service provider, which involves the interaction of a registry of

(a) a participating membership of consumers subscribers, who have and maintain a personal database on a mobile consumer controlled communication device, and
(b) a participating membership of business subscribers, which provide consumer services,
   through a consumer controlled gateway, wherein each of these groups of subscribers have communication access to the consumer controlled gateway, and yet are prevented/isolated by the gateway, from direct communication with the each other.

### SUMMARY OF THE INVENTION

The above and related objects are achieved by providing a method and a system for the electronic enrollment/registration of a consumer for access to the services of a service provider, comprising the selective disclosure of personal consumer information, from a consumer controlled database, to a service provider, as a prerequisite and incidental to the enrollment and/or subscription to a service provider's services. This personal consumer information, which is used in the electronic enrollment/registration method and a system of this invention, is resident on a personal database within a mobile consumer communication device (e.g. smart phone). This personal database is only accessible through a communication protocol of the system, which connects the mobile consumer communication device and a consumer controlled gateway.

The consumer controlled gateway comprises a self-contained, interactive application resident on its own computer server, which is accessible through various web based communication protocols, including by access to it on its own web site. This consumer controlled gateway application includes a gateway administrator (which is operated by the consumer), a registry of participating consumer subscribers, a registry of participating business subscribers, and system logic for matching a participating consumer with a data request from a participating service provider. Where a data request is initiated by a service provider, at the instigation of a consumer, (who is registered on the registry of participating consumers), the system logic associated with the gateway administration, matches a data request with a registered consumer, identifies the data fields specified in the service provider data request and apprises the registered consumer of the specific data request. If the consumer approves the supply of personal data from within his/her personal data from his/her database, he transmits enrollment/registration specific data from his/her personal database, to the gateway. The gateway supplies/matches the enrollment/registration specific data with the corresponding data fields of this service provider data request, and forwards the enrollment/registration specific data to the service provider, for the population of the enrollment/registration form. Upon the completion of the enrollment/registration form, by the service provider, the Consumer is thereby enrolled/registered on the service provider site, and permitted access to the service provider's services, The method and system of this invention, thus, only releases personal data from the Consumer database to the gateway, which corresponds and is responsive to the data fields of the service provider's data request and, at no time is the consumer's personal database directly accessible to the service provider.

In the preferred embodiments of this invention, the companies/businesses within the registry of participating web based service providers, have an “icon” or “prompt”, (in the nature of an executable link), on their respective web sites, which identifies the web based service providers as being enrolled in the registry of participating service providers, which is maintained, within the server hosting the consumer controlled gateway. This server also includes the consumer registry.

A consumer surfing the web, who desires to access the services of this participating web based service provider, clicks on this “icon” or “prompt”, on the web page of participating web based service providers, and thereby cause a “form request” to be sent from the web site to the consumer controlled gateway for completion by the gateway, (as above described).

The foregoing method and system is applicable to completion of electronic applications for credit, job applications, dating site profiles, and a myriad of other uses requiring the population of electronic forms, as a prerequisite for registration/enrollment for access to a service provider's services.

### BRIEF DESCRIPTION OF DRAWINGS

FIG. 1 illustrates a representative system of this invention having three basic interactive entities—a service provider accessible on the internet (e.g. website, which is registered on a gateway registry of service providers), a consumer controlled mobile telecommunication device, (which is registered on a gateway registry of consumer controlled mobile telecommunication device), and a server permitting interaction between a registered service provider and a registered consumer controlled mobile telecommunication device.

FIG. 2 illustrates the overall data processing architecture of the interactive system of FIG. 1.

FIGS. 3a & 3b further illustrates the data processing of a Forms Query request from a service provider, and a consumer response thereto, through the gateway of the system of this invention.

FIG. 4 is further illustration, in greater detail, of the data processing logic of FIGS. 2, 3a & 3b, for the completion of a Forms Query.

FIG. 5 illustrates the types of forms which can be populated with personal information by a consumer utilizing the system and method of this invention.

### DESCRIPTION OF THE INVENTION INCLUDING PREFERRED EMBODIMENT

The invention is herein described in detail by reference to the foregoing Figures. Where a function or element is common to more than one Figure, it is assigned the same functional characterization, or reference numeral, for simplicity of expression and ease of understanding.

As used herein, the term “Gateway” comprises a self-contained, interactive application resident on its own server, and accessible through various communication protocols. The operation of the Gateway of this invention connotes a functional interactive, self contained module, having multiple registries containing specific groups or categories of participants, and communication protocols for interaction of the Gateway with a consumer and/or service provider, who has enrolled in each of the registries of authorized participants. Each of the registered participants on Gateway has, incident to registration on the Gateway, (a) adopted a data field array, for database management of information which, is common to all Gateway subscribers and recognized by the Gateway; and, (b) a unique electronic signature which identifies each registered participant to the Gateway.

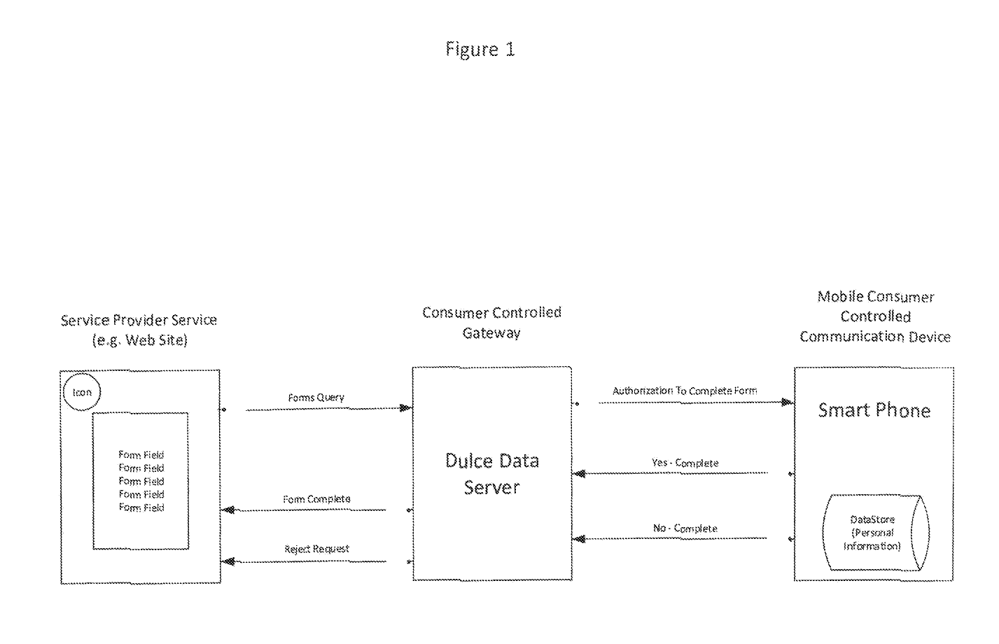

FIG. 1 depicts one of the physical embodiments of this invention, wherein a web server, hosting a consumer controlled gateway, is in communication with a web site over the interact; and, in communication with a consumer controlled, mobile telecommunication device, (e.g. a smart phone such as an iPhone). The consumer controlled, mobile telecommunication device has a secured database containing personal consumer information. In this FIG. 1, the consumer initiates a “Forms Query” by clicking on the Icon on the web site enrollment/registration service provider's web page, thereby activating an electronic link to the consumer controlled Gateway. The consumer initiated Forms Query can be initiated on a mobile telecommunication device, or traditional personal computer. The Forms Query is transmitted via the internet to the Gateway server, and the Gateway verifies the enrollment of the service provider on the service provider registry maintained by the Gateway. The Gateway then forwards a data request to the Consumer Controlled Mobile Telecommunication Device. The Consumer reviews the data request (specifically the data fields sought to be populated in the Forms Query); authorizes or rejects the release of Personal Information sufficient to fulfill the service provider's data request; and where such Consumer authorization is forthcoming, the Consumer releases enrollment/registration specific data from his/her database to the Gateway. The Gateway thereupon transmits the enrollment/registration specific data, corresponding to the service provider data request, to the service provider, and the service provider populates Form Request with such enrollment/registration specific data. The enrollment/registration process is thus complete and the consumer given access to the service provider's services.

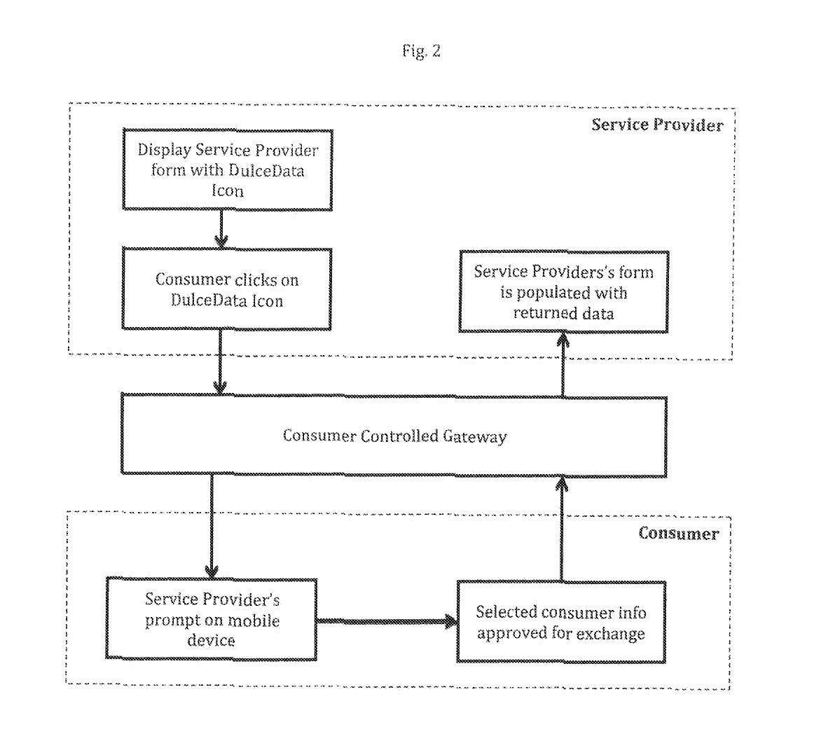

FIG. 2 illustrates the overall data processing architecture of the interactive system of this invention, including the contemplated interaction of a select group of web based service providers (which have elected to participate in the system by enrollment in a registry of service provider), with a select group of consumers on a mobile communication device (who have elected to participate in the system by enrollment in a registry of consumers), through a consumer controlled gateway (resident upon a computer server). At no time does the web site inquiry for personal information directly access the Consumer database. Moreover, the Gateway access to the Consumer Personal Information requires that the Consumer first verify the data request originated from him, approve of the data fields included in this request, prior to the Consumer release of enrollment/registration specific data to the Gateway for transmission to the service provider

Accordingly, Personal Information in the Consumer database, which is unnecessary for response to the data field in the service provider Form, is not accessible to the Gateway, nor can it be provided to the service provider. Moreover, once enrollment/registration specific data is released by the Consumer to the Gateway, and transmitted by the Gateway to the service provider, it is no resident/retained in the Gateway. The Personal Information, which is transmitted by the Gateway to the service provider to populate the service provider Form, is preferably encrypted, or otherwise in a form or format that only permits it to be used for the registration purpose intended, and not further disseminated from the populated service provider registration Form.

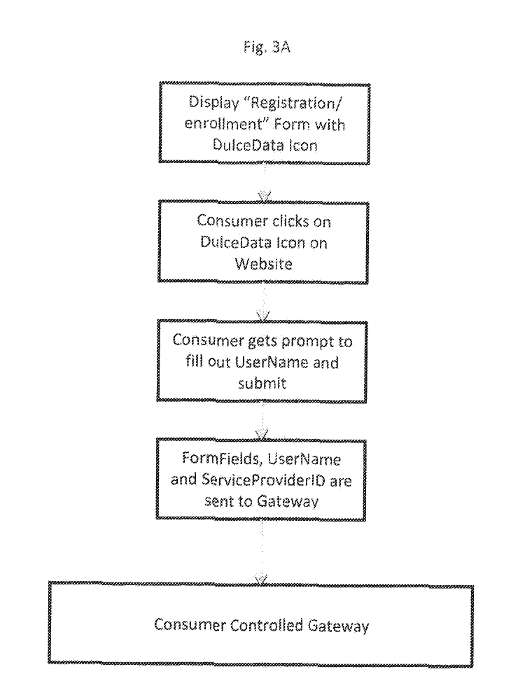

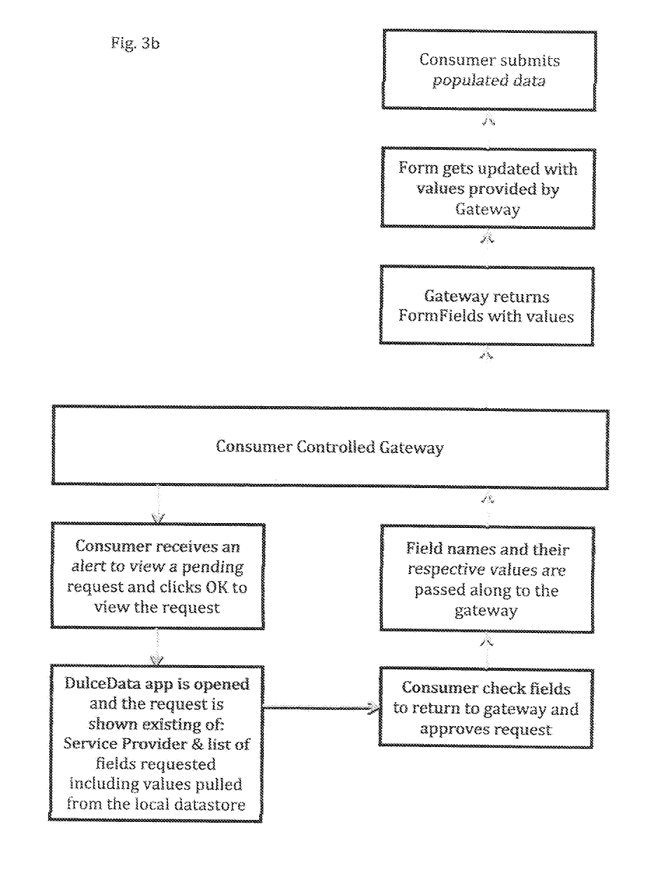

FIG. 3a illustrates a further elaboration of the interactive system depicted in FIG. 1, specifically, the initiation of Forms Query by a Consumer upon the activation of a telecommunication link, (by clicking on Dulce Data Icon), on the service provider's web page.

FIG. 3b illustrates the transmission of a Forms Query from the Gateway, to a Consumer advising him/her of a pending request for the completion/supply of Personal Information corresponding to data fields in the Forms Query. Upon being advised of the pending request, the Consumer can proceed to approve the limited supply of specific Personal Information by the Gateway, which corresponds to the data fields in pending Forms Query.

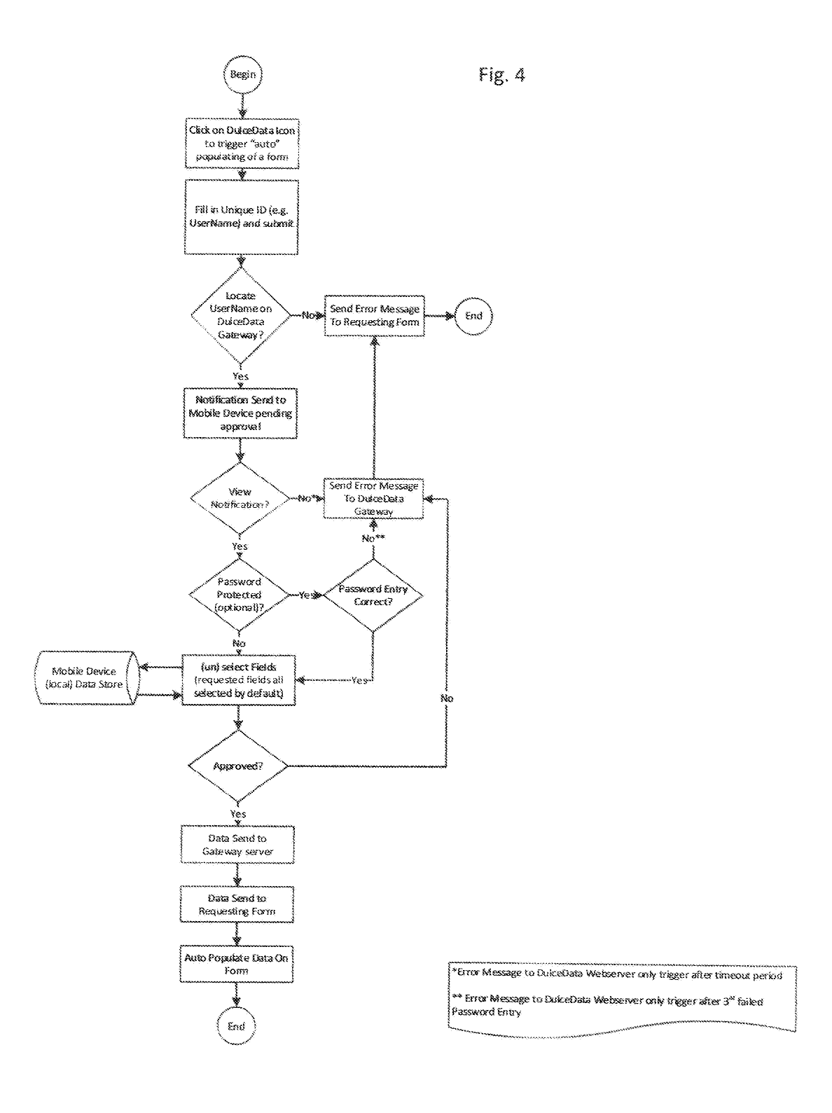

FIG. 4 is a detailed composite system logic flow diagram of FIGS. 2, 3a & 3b, including the Consumer initiation of this enrollment/registration process with a user unique ID e.g. username, and the Gateway verification of the Consumer's user name on the Gateway registry of Consumers and thereupon passing the Forms Query onto the Consumer mobile telecommunication device. Where the user name is not recognized, the Forms Query is obviously rejected.

After the Consumer is notified of the pending Forms Query, the Consumer can view the Forms Query, and affirmatively confirm that the Forms Query has been initiated by him. The Consumer, thus, accepts or rejects the request to supply of Personal Information in response to the Forms Query, and then only from the data maintained with the Consumer mobile telecommunication device which corresponds to the data fields in the Forms Query. In this FIG. 4, the Consumer can require password access to his/her Personal Information within the database on his/her mobile telecommunication device (which is both recommended and preferred). Upon the entry of the proper password, the application routine resident on the Consumer mobile telecommunication device selects from among the data fields in the database corresponding to the data fields in the Forms Query, and forwards such data from this database, and only such data, to the Gateway, This personal data, corresponding to the data fields in the Forms Query, is transmitted to the service provider for population of the web site enrollment/registration Forms Query.

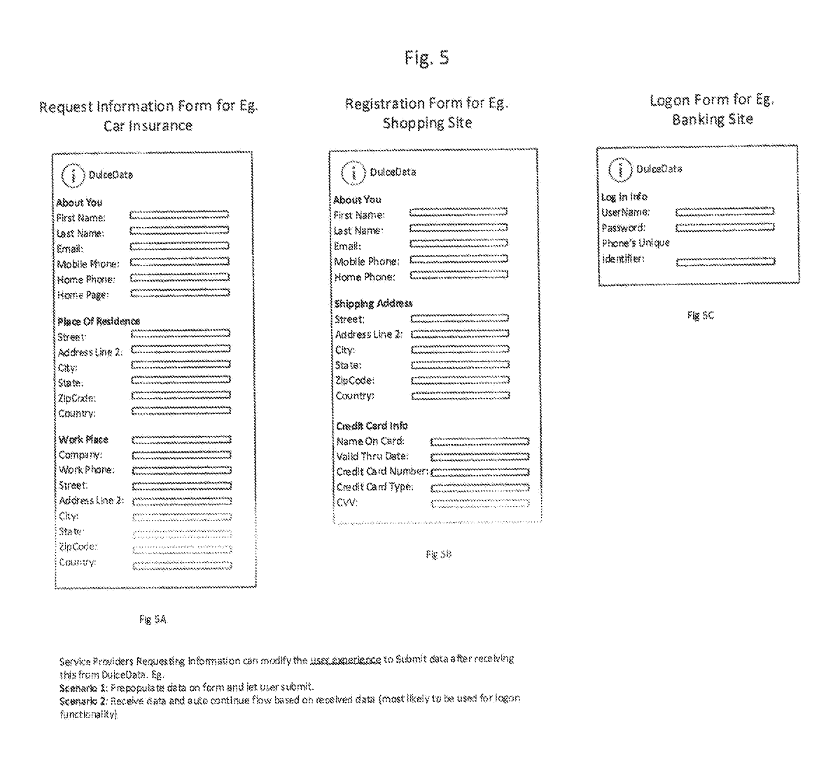

FIG. 5 depicts an assortment of forms which can be used in the enrollment/registration of a Consumer with the system and method of this invention. The Forms Query from each of these forms is different in that the data fields request some of the same information, and are yet by no means coextensive. Thus, only so much of the personal information need to populate each form would be provided for completion of each such form by the Consumer, without revealing information beyond that which is requested.

The system and method of this invention has been described herein by reference to a number of representative embodiments illustrative of a hardware configuration and data processing logic for a number of specific applications of the invention. It is understood that this invention has application to additional consumer uses for the controlled disclosure of private and personal information, e.g. job applications, credit applications, dating sites, and the like. Accordingly, the foregoing is not intended as delineating the scope of exclusive protection to which this invention is entitled, which has been reserved for the Claims which follow.

What is claimed is:

1. In a system for supplying personal consumer information, from a consumer database, to a service provider, as a prerequisite for, and incident to, enrollment/registration of a consumer on a service provider site for access to a service provider's services, wherein the improvement comprising:
a. An executable program, resident on a computer server, having multiple functional and interactive modules, including
i. a registry of consumers who are enrolled participants in the system;
ii. a registry of service providers who are enrolled participants in the system;
iii. a system gateway having
1. an administrator module, under control of a consumer, said gateway having a telecommunication protocol for interaction with consumers who are enrolled participants in said system, and with of service providers who are enrolled participants in said system;
b. at least one telecommunication protocol for interaction of said gateway, on a dedicated server, with a database containing personal consumer information on a mobile consumer telecommunication. device controlled by said consumer;
c. at least one telecommunication protocol for interaction of said gateway, on a dedicated server, with a telecommunication link to said service provider site for generation of a forms inquiry for enrollment/registration specific information from a consumer enrolled in said consumer registry;
d. an executable link for installation on said service provider's site, for initiation of a forms inquiry to said gateway for personal enrollment/registration specific information, relative to a consumer enrolled in said consumer registry;
e. a personal database, for installation on a mobile telecommunication device of said consumer, for the collection and organization of personal consumer information on said mobile telecommunication device, said personal consumer information being identified and segregated for each consumer enrolled in said consumer registry, and organized in data fields corresponding to data fields of said forms inquiry from said service provider.
f. A server for maintaining telecommunications between said administration module of said gateway, with each of said service provider sites, and each of said mobile telecommunication devices of said consumers;
g. Instructions for installation and configuration of said executable link on said service provider site, for communication of said service provider site with said gateway; and
h. Instructions for installation and configuration of said personal database on a mobile telecommunication device, for communication of said mobile telecommunication device with said gateway.

2. The improved system of claim 1, wherein said forms query requests personal consumer information for enrollment/registration of a consumer on a service provider site for access to banking services.

3. The improved system of claim 1, wherein said forms query requests personal consumer information for enrollment/registration of a consumer on a service provider site for access to a credit card services

4. The improved system of claim 1, wherein said forms query requests personal consumer information for enrollment/registration of a consumer on a service provider site for access to department store services.

5. The improved system of claim 1, wherein said forms query requests personal consumer information for enrollment/registration of a consumer on a service provider site for access to magazine subscription services.

6. The improved system of claim 1, wherein said forms query requests personal consumer information for enrollment/registration of a consumer on a service provider site for access to employment services.

7. The improved system of claim 1, wherein said forms query requests personal consumer information for enrollment/registration of a consumer on a service provider site for access to on-line shopping services.

8. The improved system of claim 1, wherein said forms query requests personal consumer information for enrollment/registration of a consumer on a service provider site for access to government services.

9. The improved system of claim 1, wherein said forms query requests personal consumer information for enrollment/registration of a consumer on a service provider site for access to motor vehicle registration services

10. The improved system of claim 1, wherein said forms query requests personal consumer information for enrollment/registration of a consumer on a service provider site for access to on-line dating site services

11. A method for enrollment/registration of a consumer on a service provider site for access to a service provider's services, comprising:
a. Providing a system, resident on a computer server, for supplying personal consumer information, from a consumer database, to a service provider, as a prerequisite for, and incident to, enrollment/registration of a consumer on a service provider site for access to a service provider's services, having an executable program having multiple functional and interactive modules, including
i. a registry of consumers who are enrolled participants in the system;
ii. a registry of service providers who are enrolled participants in the system;
iii. a system gateway having
1. an administrator module, under control of a consumer, said gateway having a telecommunication protocol for interaction with consumers who are enrolled participants in said system, and with of service providers who are enrolled participants in said system;
b. Initiating of a service provider request for consumer enrollment/registration for access to said service provider services by said consumer activating an electronic link on said service provider's site, whereby a forms query, having a plurality of data fields, is transmitted to said gateway of said system;
c. Verifying said forms query originated from a service provider site by said consumer;
d. Approving release of personal consumer information, from a database resident of said a mobile telecommunication device, corresponding to said data fields in said forms query, upon receipt of consumer acknowledgement that said release is authorized;
e. Uploading select personal data from said database on said mobile telecommunication device, corresponding to said data fields in said forms query, to said gateway;
f. Transferring said select personal data, corresponding to said data fields in said forms query, from said gateway to said service provider for population of said data fields in said forms query, thereby enrolling/registering said consumer as an authorized user of said service provider site;

12. The method of claim 11, wherein said forms query requests personal consumer information for enrollment/registration of a consumer on a service provider site for access to banking services.

13. The method of claim 11, wherein said forms query requests personal consumer information for enrollment/registration of a consumer on a service provider site for access to a credit card services

14. The method of claim 11, wherein said forms query requests personal consumer information for enrollment/registration of a consumer on a service provider site for access to department store services.

15. The method of claim 11, wherein said forms query requests personal consumer information for enrollment/registration of a consumer on a service provider site for access to magazine subscription services.

16. The method of claim 11, wherein said forms query requests personal consumer information for enrollment/registration of a consumer on a service provider site for access to employment services.

17. The method of claim 11, wherein said forms query requests personal consumer information for enrollment/registration of a consumer on a service provider site for access to on-line shopping services.

18. The method of claim 11, wherein said forms query requests personal consumer information for enrollment/registration of a consumer on a service provider site for access to government services.

19. The method of claim 11, wherein said forms query requests personal consumer information for enrollment/registration of a consumer on a service provider site for access to motor vehicle registration services

20. The method of claim 11, wherein said forms query requests personal consumer information for enrollment/registration of a consumer on a service provider site for access to on-line dating site services
